(19) United States
(12) Patent Application Publication
(10) Pub. No.: US 2016/0188468 A1
(43) Pub. Date: Jun. 30, 2016

(54) IMPLEMENTATION OF DATA COHERENCE AMONG DEVICES

(71) Applicant: Intel Corporation, Santa Clara, CA (US)

(72) Inventor: Ganesh P. Rao, Portland, OR (US)

(21) Appl. No.: 14/583,259

(22) Filed: Dec. 26, 2014

(51) Int. Cl. G06F 12/08; G06F 9/54

(52) U.S. Cl. CPC G06F 12/0815; G06F 9/547; G06F 2212/621

(57) ABSTRACT

Systems and methods may provide coherence between devices that share one or more variables during an execution of applications. State variables may be associated with data in cache, and may take on a Modified, Exclusive, Shared, or Invalid (MESI) value indicative of a state of the corresponding data. The data may be updated across all, or a portion, of the devices to provide data coherence among the devices as needed based on, for example, the state variable.

### TECHNICAL FIELD

Embodiments generally relate to data coherence. More particularly, embodiments relate to a state variable for data coherence.

### BACKGROUND

Data coherence may refer to a consistency of data that may be shared among a number of computer resources. In a single device having a plurality of processors, for example, each processor may include a dedicated cache and data written to one cache by one processor may not agree with data written to another cache by another processor. For example, variables that correspond to the data may have different values when the data is stored at the dedicated caches, and the different values may be provided depending on which of the dedicated caches are read.

Devices may be distributed and cooperate with one another over a network. For example, one or more server devices may be connected to one or more client devices over a network, wherein each of the devices may run applications that access data which may be shared among the devices. Since each device may have a processor that is capable of altering the data, the shared data may lack coherence (i.e., may not be the same) across the devices. Thus, for example, a server may have one value for a data variable, and a networked client device may have another value for the same data variable.

In one example, a group of players each using a local device to play one another over a network may have differences in scores corresponding to a player (e.g., a score that a player has on a local device may not match a score recorded for the player on another player's device). In another example, data may lack coherence where data may be manually edited on multiple devices (e.g., business forms being simultaneously edited on multiple devices) and saved on a server. In a further example, data may lack coherence where data is generated by sensors attached to devices running applications in an “Internet of Things,” where one or more values may be shared across multiple devices. It may be possible to provide coherency of data among disparate devices by regularly copying all data from each device to the other devices, but regularly copying may take up substantial hardware, network, and software resources.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a system to establish data coherence according to an embodiment;

FIG. 2 is a block diagram of an example of an architecture to establish data coherence according to an embodiment;

FIG. 3 is a block diagram of an architecture to establish data coherence between a client device and a server device according to an embodiment;

FIG. 4 is an example of a state transition diagram according to an embodiment;

FIG. 5 is a flowchart of an example of a method of utilizing state information to characterize changes to a variable according to an embodiment;

FIG. 6 is a block diagram of an example of a processor according to an embodiment; and

FIG. 7 is a block diagram of an example of a computing system according to an embodiment.

### DETAILED DESCRIPTION

Various devices, including mobile devices, smart phones, gaming devices, tablets, notebooks, etc., may run applications that process data which may be shared with other devices (e.g., remote servers) over a network (e.g., a cloud). In addition, it may be desirable that a server and/or other persistent storage of data include the most current data that is shared and stored on the server. Client devices may, however, be running an application that shares data (e.g., with a server) that may be altered by the server and/or by one or more client devices. Thus, coherence of the data may be needed to ensure that the data available to a processor on a local device (e.g., a client device) is the same as corresponding data at the remote device (e.g., server, other client devices, etc.).

In particular, it may be challenging to maintain data coherence between two devices during game play using mobile devices. For example, a user of a first mobile device may be running a game application that generates a score based on a number of points the user has scored. The user's ranking may be based on the scores of other players who may be playing the same game on respective second mobile devices. As the game is played using the various devices, the value of the data on the first device that indicates the user's ranking may become invalid, and vice versa.

Data may be held in a runtime cache as a variable in a cache line. There are various representations of data in a computer system and/or software. One example representation may include a name-value pair (NVP), which may also be referred to as an attribute-value pair. Data is provided in pairs in the NVP, wherein a first portion of the pair represents a name of a variable and a second portion of the pair provides a value of the variable. In a gaming context, an NVP may consist of a name of a user (e.g., player, gamer, etc.) and a performance of the player (e.g., in a tournament). Thus, the NVP “JD 150” may include data to be shared, which may refer to the name of the user identified by the initials “JD” and a value 150 of a variable “score”.

Accordingly, the user may play the game on a local client device in competition with other users playing the same game on other client devices local to the other users and a leader board may access the NVP data on each of the client devices to generate a ranking to use in the leader board. The leader board may be maintained on a server, and may entail the server having current values for the NVPs (i.e., user scores) from all of the players. In one embodiment, latest (e.g., most current) data may be stored on a server, and the stored data may be used to over-write the corresponding data on each user's client device on an as-needed basis. Advantageously, a total amount of data that is to be transferred between devices to maintain data coherence may be relatively reduced, thereby saving on computer and/or communications resources, including power, memory, storage, and so on.

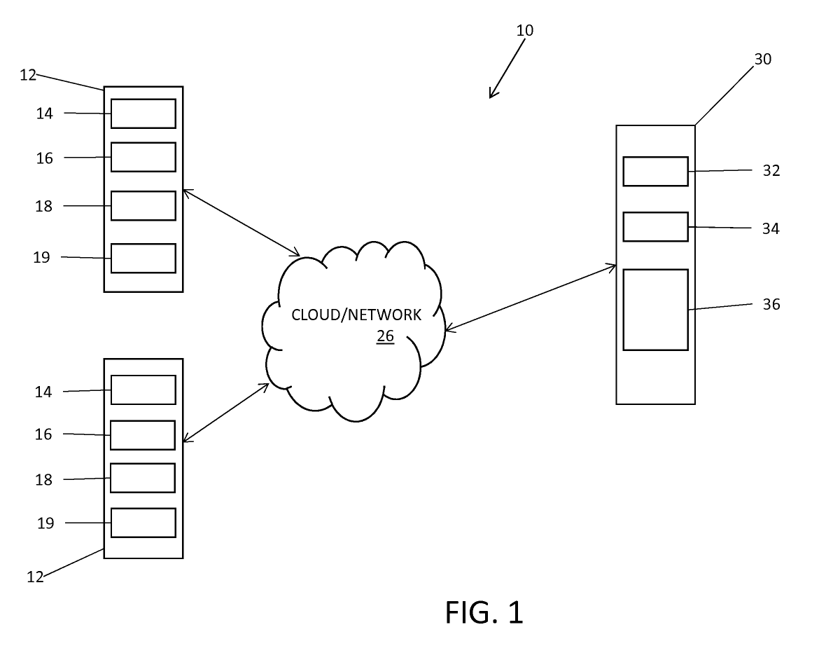

Turning now to FIG. 1, a block diagram of an example of a system that provides a measure of data coherence across a network is shown according to an embodiment. Two client devices 12 may communicate via a network 26 (e.g., a cloud) with a server 30. There may be more or fewer client devices 12 than are shown in FIG. 1. Each client device may have a respective processor 14, may run a respective application 16, and may include a respective run-time cache 18 that may store data on a session-by-session basis. The client devices 12 may also include a memory 19, such as a random access memory (RAM) chip, a hard drive, a solid-state drive, and/or any other mechanism for storing data persistently between sessions.

In the illustrated example, the client devices 12 may be networked together via the network 26, and/or may be networked via the network 26 to the server 30. The server 30 may include at least one processor 32, may run an application 34, and may include a persistent storage 36 to store data. The persistent storage 36 may be implemented in a persistent software cache, in hardware, or any combination thereof. For example, the persistent storage 36 may include a RAM chip, a hard drive, a solid-state drive, and/or any other mechanism to store data. The application 16 may provide a game play environment for each user of the client devices 12. In addition, the client devices 12 that may be networked may include smart phones, computers, notebooks, tablets, gaming consoles, Internet of things (IoT) devices with sensors, and so on, or any combination thereof.

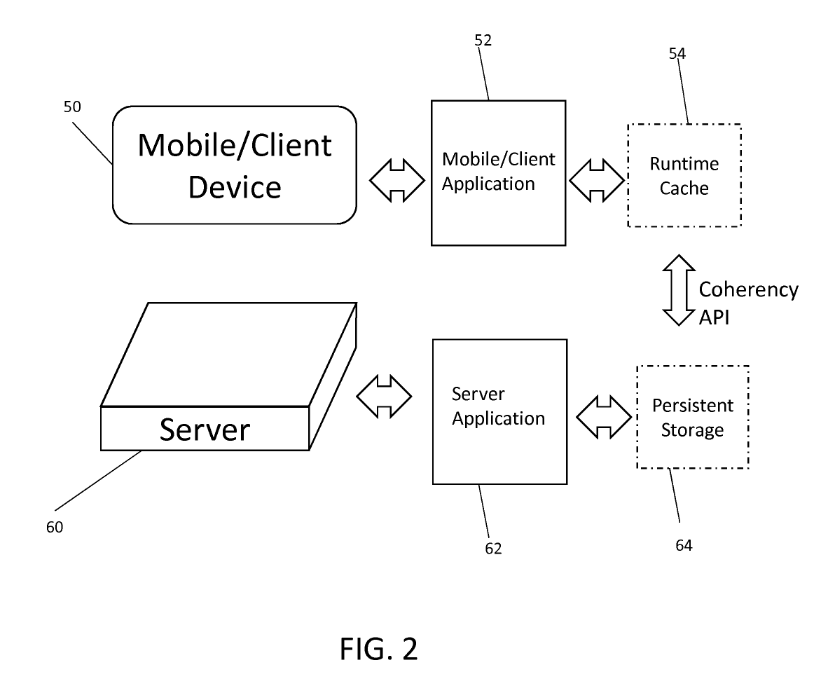

FIG. 2 illustrates an example of an architecture to establish data coherence across two devices in accordance with an embodiment. A first device 50 may be a client-side mobile device on which a mobile application 52 may run. In one example, the mobile application 52 may include a game that may, at the software level, have a runtime cache 54. A second device 60 may include a server on which a server application 62 may run, which may utilize a persistent storage 64 for storing data. The persistent storage 64 may be implemented in software as persistent cache, may be implemented in hardware, or as a combination of hardware and software. The persistent storage 64 may hold values for data that may be considered to be current, and when utilized, the values may be copied into the runtime cache 54 of the device 50.

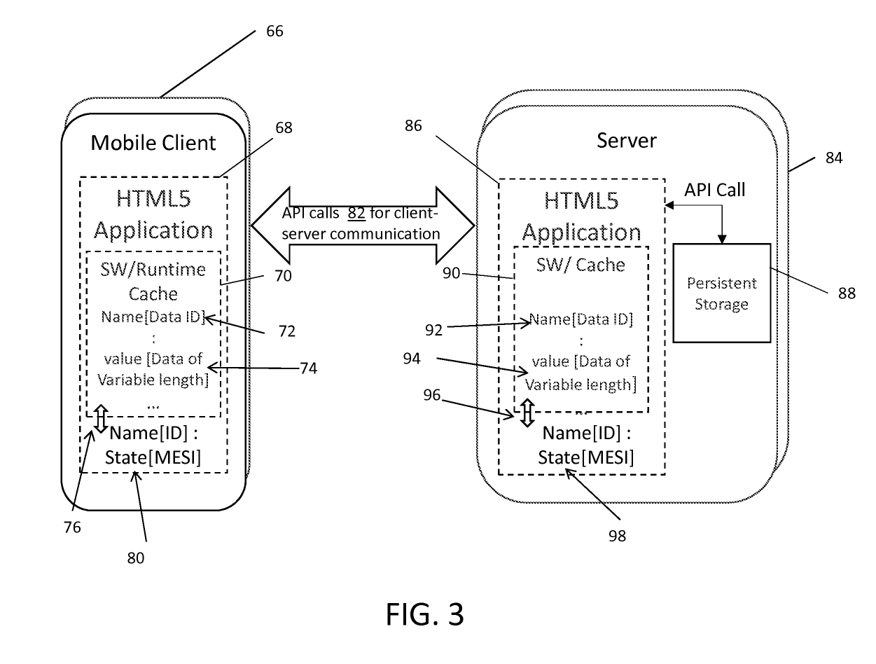

Turning now to FIG. 3, an architecture to establish data coherence between two devices is shown according to an embodiment. A mobile client device 66 may run an application such as, for example, a Hyper Text Markup Language (e.g., HTML5) application 68. In one example, the HTML application 68 may include a game, a business application, an application to collect sensor data, and so on. As part of the HTML5 protocol, the HTML5 application 68 may have access to a runtime cache 70, which may be a temporary store of data. In one example, the data stored in the runtime cache 70 may be in NVP form (although other representations of data may be employed). As illustrated in FIG. 3, for example, NVP data may include a name 72 to identify the data, and a corresponding value 74 for a variable.

A “Illinois” or Modified-Exclusive-Shared-Invalid (MESI) state variable 80 may be associated with each name 72 via a state space logic Application Programming Interface (API) 76. Thus, for every variable and/or element of data of interest, there may be one unique state variable 80. In the illustrated example, the state variable 80 indicates the state of the associated NVP by taking on one of four values: Modified (M), Exclusive (E), Shared (S), or Invalid (I), as discussed in greater detail below.

Each device that is connected to another device may include an updatable set of state variables for NVPs. The state variables may be locally stored in cache and/or memory of the devices. In addition, the values of the state variables that are stored in cache and/or memory may be shared with the other devices through, e.g., API calls 82 originating from any connected device. For example, the API calls 82 may issue from the mobile client device 66 and/or from a server device 84. In one example, the API calls 82 may follow an asynchronous API protocol (e.g., an AJAX call), the API calls 82 may be implemented as a web socket, and so on. Moreover, the API calls 82 may provide a snooping logic by which a device may be kept apprised of changes to the state variables arising from any of the connected devices.

The server 84 may run an application 86, which may be an HTML 5 application or another application (e.g., Node.js®, a trademark of Joyent, Inc.). In addition, the application 86 may also run a Java® program. A software cache 90 may be implemented within the application 86, which may be connected to a persistent storage 88. The persistent storage 88 may, for example, be implemented in software and may itself be internal to the application 86. The persistent storage 88 may include hardware such as, for example, a hard drive, a solid-state drive, one or more memory chips, and so on. The persistent storage 88 may be implemented as a combination of software and hardware.

The persistent storage 88 may store one or more NVPs that correspond to NVPs on a client side, such as NVPs that correspond to the mobile client device 66. For example, a name 92 on the server side may logically correspond to the name 72 on the client side. Similarly, a value 94 on the server side may logically correspond to the value 74 on the client side. Notably, although the actual values for 94 and 74 may not, at a particular time, match, the names 92, 72 may refer to the same entity (e.g., a particular player.) The NVPs may be stored via an API call into the persistent storage 88, and the persistent storage 88 may hold the most current values of the NVPs and their associated “Illinois” or Modified-Exclusive-Shared-Invalid (MESI) state variables 98.

Although FIG. 3 shows one mobile client device 66 in communication with a server 84, it should be understood that a plurality of mobile client devices may be implemented. Additionally, persistent storage may be provided on one or more mobile devices instead of, or in addition to, a server. In addition, coherence may be provided between the run-time cache 70 of the mobile client device 66 and the persistent storage 88 of the server 84. Coherence of data, which may be used in a plurality of devices, may be provided by utilizing the state variable 80 and the state variable 98 located on client side devices and server side devices, respectively. The state variables 80, 98 may have one of the following four state values.

Modified (M). In the M state, an NVP containing valid data may be present only in the current run-time cache 70 of the mobile client device 66, and it is considered “dirty,” in which the NVP has been modified from (i.e., does not match) a value of a corresponding NVP stored in, e.g., the server 84 in persistent storage 88.

Exclusive (E). In the E state, an NVP containing valid data of interest, such as a particular NVP, is present in the current run-time cache 70 of the mobile client device 66, and it is considered “clean,” in which the NVP matches a value of a corresponding NVP stored in, e.g., the persistent storage 88 on the server 84.

Shared (S). In the S state, an NVP is also clean, in which the NVP matches a value on the server side in persistent storage, and may be shared with at least one other client device. As noted above, while FIG. 3 shows only one client device for illustration, there may be more than one client device.

Invalid (I). In the I state, an NVP is not valid, and thus the data it contains is not valid.

The state of an NVP may change based on, for example, API read/write calls (e.g., “transactions”) to the NVP from a local client device, a server, another client device, or combinations thereof. Notably, a call may indicate that an event may have occurred to an NVP, which may include an event that changes the state of the NVP. By tracking events (e.g., via calls), state-space logic at run-time may be used to determine whether an NVP is to be updated and/or a value of the NVP is to be propagated to other caches, storage locations, and so on. Thus, coherence of data across a plurality of devices is to be maintained.

Advantageously, the use of a state variable as a marker for an NVP, to indicate when a change has occurred that merits a transmission of data in the NVP from one device to another, may provide a relatively more economical use of computer resources and/or communications resources than conventional approaches (e.g., approaches that periodically update all data). In addition, the use of a state variable as a marker may offer relatively better tracking of only NVPs that an application may make use of Also, state information may be used to determine when a value of a variable should be updated, erased, and/or locked (e.g., locked against being written over by other users), which may provide for coherency of data among several devices.

On the mobile client device 66, the state space logic API 76 may provide an update to the state variables 80 corresponding to the NVPs on the client side as may be warranted by changes to the NVPs on the client side. Similarly, on the server 84, a state space logic API 96 may provide an update to the state variables 98 corresponding to the NVPs on the server side as may be warranted by changes to the NVPs on the server side. In some embodiments, changes to a state variable on any one device may be propagated as changes to the corresponding state variables on all of the other devices.

In addition, read and/or write calls may be of interest in and of themselves, independently of (e.g., without regard to) calls preceding the read and/or write calls. Moreover, the read and/or write calls may take on a particular meaning in light of a particular call preceding the read and/or write calls. For example, in examples shown in FIGS. 1 and 3 in which a mobile client interacts with a server (and/or other mobile clients, e.g., connected through the server), the following calls may be of interest for an ability to alter the state of an NVP.

Client-R: Client Read. A client device (which may be a mobile device) may read an NVP from a client-side run-time cache of the client device.

Client-W: Client Write. A client device may write a value for an NVP to a client-side run-time cache of the client device.

Client-WX: Client Write Exclusive. A request may be made by a client device to gain exclusive ownership of a name (e.g., a variable). A server may approve the request with a Server-RX call, discussed below, which may include an identity of the client device and a name for which exclusive ownership has been granted. The client device may, therefore, acquire exclusive ownership of the address (e.g., data corresponding to the name), and may write to the address. In addition, all other client devices may invalidate the NVP on respective caches of the client devices.

Delete: An NVP in a run-time cache may be deleted so that it has no value.

Server-R: Server Read. A server may read a value of an NVP in a run-time cache of a client. The read may occur in response to a request of another client device, and/or the server may itself be running an application that requires the server to read the data (e.g., client data).

Server-RX. Server Read Exclusive. In some contexts, a server may read a value in an NVP in run-time cache of a client, and mark the value as being available to be written over. In other contexts, such as when following a Client-W call, the server may read the value of the NVP in the run-time cache of the client, and mark the copy in the run-time cache of the client as the only valid copy to give the client device a lock over the variable.

The foregoing calls may arise in the operation of an application running on a server and/or a client side device, and state variables associated with a given NVP may also change as the foregoing calls are made.

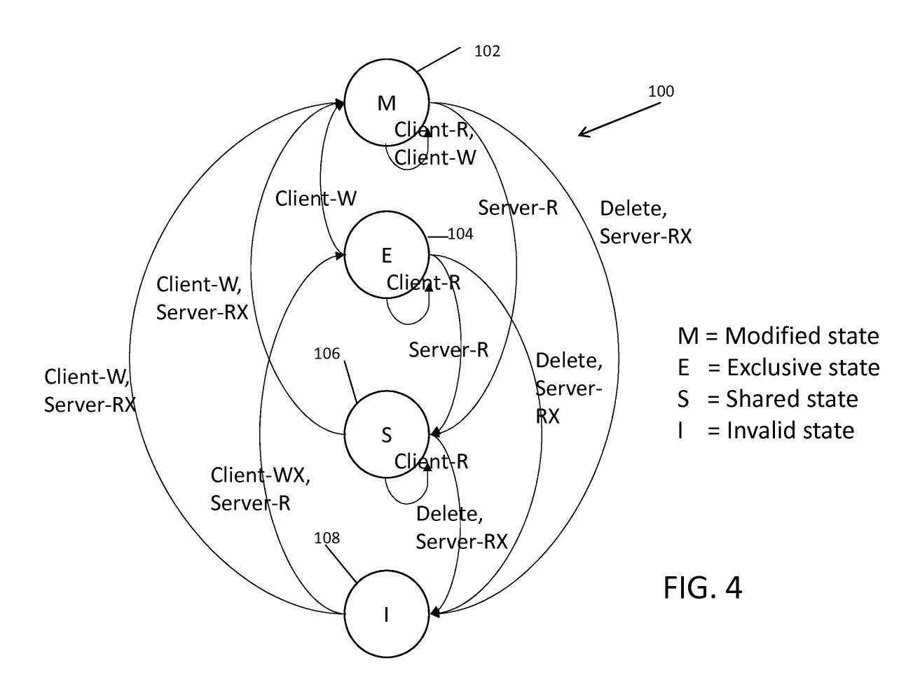

FIG. 4 shows a state transition diagram 100 according to an embodiment. Notably, a state variable associated with a variable of interest on a client device may change in response to various calls. Four states shown in the state transition diagram 100 include an M state 102, an E state 104, an S state 106, and an I state 108. Example Table 1 provides, in tabular form, a summary of how the states 102-108 may change in response to a call.

Example Table 1

| Current State | Call | Next State |
|---|---|---|
| Modified (M) | Client Read | M |
| | Client Write | M |
| | Server Read | S |
| | Delete | I |
| | Server Read Exclusive | I |
| Exclusive (E) | Client Read | E |
| | Server Read | S |
| | Delete | I |
| | Server Read Exclusive | I |
| | Client Write | M |
| Shared (S) | Client Read | S |
| | Client-Write Exclusive | I |
| | followed by Server Read | |
| | Exclusive | |
| | Delete | I |
| | Client Write | M |
| | Client-Write followed by | M |
| | Server Read Exclusive | |
| Invalid (I) | Client Write Exclusive | E |
| | followed by Server Read | |
| | Server Read | M |
| | Client Write followed by | M |
| | Server Read Exclusive | |
| | Client Write | |

Not all change-of-state events may prompt a transfer of NVP data from one device to another device. For example, some API calls for a client-server communication assert a data state change without making modifications to a value of the NVP. NVP data may be transferred from one device to another device when, for example, there has been a state change followed by a Server-R and/or a Server-RX call.

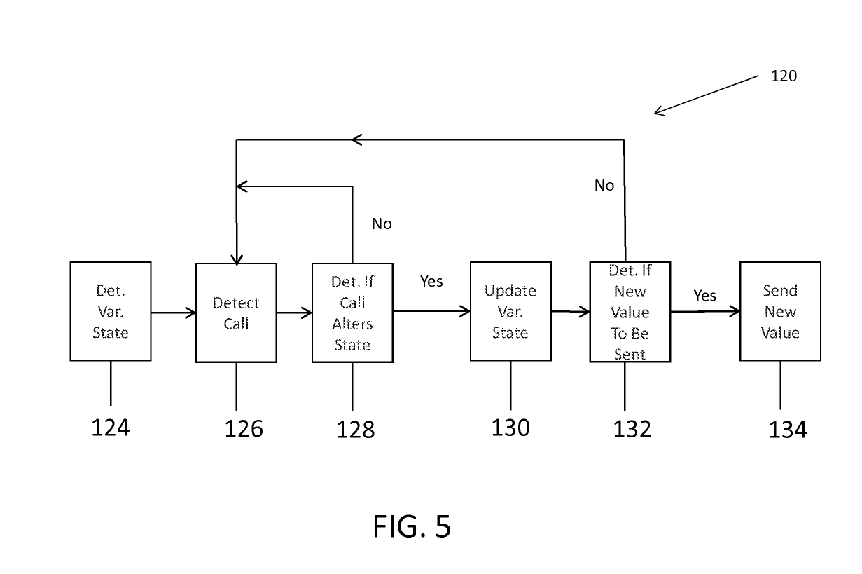

FIG. 5 shows a flowchart of an example of a method 120 of using state information concerning a variable to establish data coherence among a plurality of devices. The method 120 may be implemented as a set of logic instructions stored in a machine-or computer-readable storage medium such as random access memory (RAM), read only memory (ROM), programmable ROM (PROM), flash memory, etc., in configurable logic such as programmable logic arrays (PLAs), field programmable gate arrays (FPGAs), complex programmable logic devices (CPLDs), in fixed-functionality logic hardware using circuit technology such as application specific integrated circuit (ASIC), CMOS or transistor-transistor logic (TTL) technology, or any combination thereof. For example, computer program code to carry out operations shown in the method 120 may be written in any combination of one or more programming languages, including an object oriented programming language such as C++ or the like and conventional procedural programming languages, such as the “C” programming language or similar programming languages. Moreover, the method 120 may be implemented using any of the herein mentioned circuit technologies.

The method 120 begins at illustrated processing block 124, where a current state of a variable may be determined. For example, the variable may be of an NVP type, discussed above, and the variable may include a state variable associated thereto. The value of the state variable may be determined at the processing block 124 as one of M, E, S, or I.

Illustrated processing block 126 detects one or more API calls, which may include one or more of a Client-W, Client-R, Client-WX, Server-R, or Server RX call. Illustrated processing block 128 determines whether a detected call is to alter the state variable as per a transition rule. In one example, the transition rule may include one or more rules shown in Example Table 1 and shown in FIG. 4, discussed above. If the detected call does not alter the state variable, then control loops back to processing block 126 to await a detection of a next API call. If the variable state is to be altered by the call, then illustrated processing block 130 updates the state variable and asserts the state change to the other devices.

A state change may always be asserted (i.e., propagated to other devices). A change in the state variable may indicate that the NVP that is associated with the state variable has changed and that a new value may need to be propagated to the other devices. The data value associated with the state variable may be propagated to other devices in response to a detection at illustrated processing block 132 of, e.g., a Server-R and/or Server-RX call. Propagation of the new value to the other devices occurs at illustrated processing block 134. Thus, data coherency among the devices may be accomplished.

The processing blocks may be implemented in the various combinations of hardware and/or software elements note above. Thus, in one embodiment processing block 124 may be implemented in hardware and/or software, and may include a state variable determiner to determine the value of a state variable. Similarly, processing block 126 may include a call detector to detect calls. Processing block 130 may include a state variable updater to change the values of state variables. Processing block 132 may include a data update determiner to determine whether to update data, and may determine the devices with which updates of data are to be sent or shared. Processing block 134 may include a data updater to update data on devices. It will be appreciated that other implementations of the method are possible.

By associating data of interest (e.g. named variable pairs) with state variables whose change of state may track changes made to data in persistent storage, a client may track the changes that are pertinent to applications running on connected devices in real-time. Thus, coherence may be established by updating just such variables according to a state transition diagram in a way that may make relatively more economical use of computer resources and/or bandwidth. For example, where a variable has not been altered, and/or has been altered but not in a context requiring that it be shared with other devices at that moment, then the value may not be propagated between a client and a server, and may therefore save bandwidth on a communications channel connecting the client and the server. In addition, requirements may be relatively reduced, and speed may be relatively enhanced.

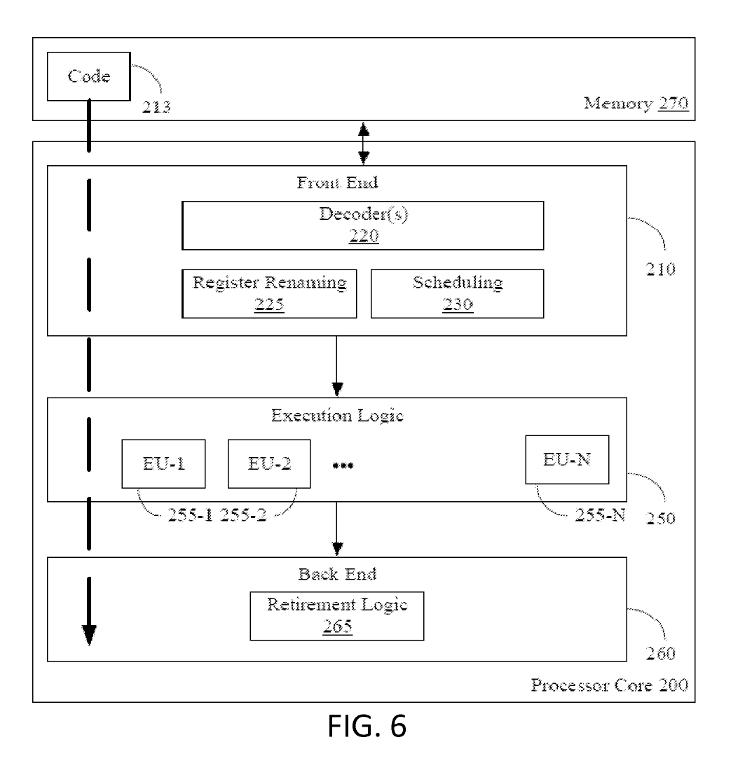

FIG. 6 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 6, a processing element may alternatively include more than one of the processor core 200 illustrated in FIG. 6. The processor core 200 may be a single-threaded core or, for at least one embodiment, the processor core 200 may be multithreaded in that it may include more than one hardware thread context (or “logical processor”) per core.

FIG. 6 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the state transitions in the state transition diagram 100 (FIG. 4) and/or the method 120 (FIG. 5), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 6, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

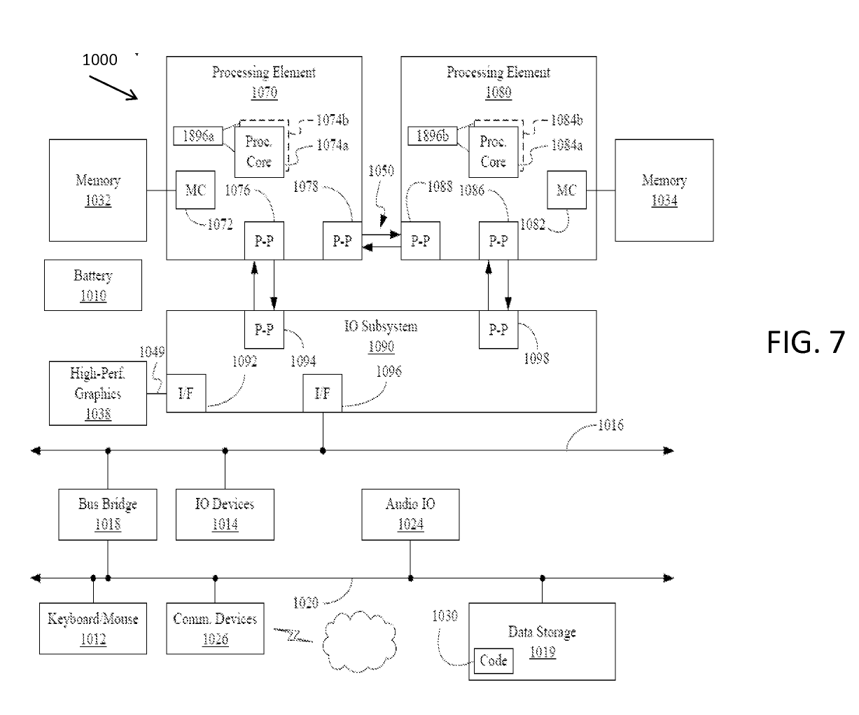

Referring now to FIG. 7, shown is a block diagram of a computing system 1000 (e.g., server, blade, desktop computer, notebook computer, tablet computer, convertible tablet, smart phone, mobile Internet device/MID, wearable computer, media player, etc.) embodiment in accordance with an embodiment. Shown in FIG. 6 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 7 may be implemented as a multi-drop bus rather than point-to-point interconnect.

As shown in FIG. 7, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 6.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076, 1086, respectively. As shown in FIG. 6, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 6, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the state transitions in the state transition diagram 100 (FIG. 4) and/or the method 120 (FIG. 5), already discussed, and may be similar to the code 213 (FIG. 6), already discussed. Thus, the code 1030 may be used to automatically schedule the retraining of any of the interconnects and/or communication busses shown in FIG. 7. Further, an audio I/O 1024 may be coupled to second bus 1020 and a battery 1010 may supply power to the computing system 1000.

Note that other embodiments are contemplated. For example, instead of the point-to-point architecture of FIG. 7, a system may implement a multi-drop bus or another such communication topology. Also, the elements of FIG. 6 may alternatively be partitioned using more or fewer integrated chips than shown in FIG. 7.

To the extent various operations or functions are described herein, they may be described or defined as hardware circuitry, software code, instructions, configuration, and/or data. The content can be embodied in hardware logic, or as directly executable software (“object” or “executable” form), source code, high level shader code designed for execution on a graphics engine, or low level assembly language code in an instruction set for a specific processor or graphics core. The software content of the embodiments described herein can be provided via an article of manufacture with the content stored thereon, or via a method of operating a communication interface to send data via the communication interface.

A non-transitory machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface is configured by providing configuration parameters or sending signals to prepare the communication interface to provide a data signal describing the software content. The communication interface can be accessed via one or more commands or signals sent to the communication interface.

Various components described can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

### ADDITIONAL NOTES AND EXAMPLES

Example 1 may include a method of providing data coherence, comprising determining a value of a state variable, wherein data on a device is associated with the state variable, detecting a call pertaining to one or more of a read or a write of data on the device, changing a value of at least the state variable based on the call, and determining whether to update corresponding data on one or more other devices based on a change in the value of the state variable and an evaluation of a need to propagate a change in the corresponding data to the one or more other devices.

Example 2 may include the method of Example 1, wherein the data comprises at least one name-value pair (NVP) of data.

Example 3 may include the method of any one of Examples 1 to 2, wherein the state variable is stored in one or more of a cache on the device, or a persistent memory on the device.

Example 4 may include the method of any one of Examples 1 to 3, wherein the call originates from at least one of the one or more other devices.

Example 5 may include the method of any one of Examples 1 to 4, wherein the state variable includes a value of one or more of Modified, Exclusive, Shared, or Invalid.

Example 6 may include the method of any one of Examples 1 to 5, wherein the device includes a client mobile device.

Example 7 may include the method of any one of Examples 1 to 6, wherein the corresponding data is updated on the one or more other devices based on an evaluation of the change in the value of the state variable and an evaluation of the call.

Example 8 may include the method of any one of Examples 1 to 7, wherein the corresponding data is updated from a persistent memory to a cache memory.

Example 9 may include the method of any one of Examples 1 to 8, further including generating an Application Programming Interface (API) call to provide a channel, communicating the change in the value of the state variable, and monitoring the change in the value of the state variable.

Example 10 may include the method of any one of Examples 1 to 9, further including updating the corresponding data in accordance with the determination.

Example 11 may include at least one computer readable storage medium comprising one or more instructions that when executed on a computing device cause the computing device to determine a value of a state variable that is to be associated with data on a device, detect a call to read and/or write the data that is to be associated with the state variable, change a value of at least the state variable based on the call, determine whether to update corresponding data based on a change in the value of the state variable, and update the corresponding data in accordance with the determination.

Example 12 may include the at least one computer readable storage medium of Example 11, wherein the instructions, when executed, cause a computing system to determine whether the value of the state variable is Modified, Exclusive, Shared, or Invalid.

Example 13 may include the at least one computer readable storage medium of Example any one of Examples 11 to 12, wherein the instructions, when executed, cause a computing system to update the corresponding data stored on the one or more other devices based on the change in the value of the state variable and/or the call.

Example 14 may include the at least one computer readable storage medium of any one of Examples 11 to 13, wherein the instructions, when executed, cause a computing system to store data in a persistent memory.

Example 15 may include the at least one computer readable storage medium of any one of Examples 11 to 14, wherein the device is a client.

Example 16 may include the at least one computer readable storage medium of any one of Examples 11 to 15, wherein the instructions, when executed, cause a computing system to generate an Application Programming Interface (API) call to provide a channel on which the device monitor changes to one or more state variables.

Example 17 may include a device for storing data in coherence with other devices, comprising a state variable determiner to determine a value of a state variable that is to be associated with data on a device, a call detector to detect a call to read and/or write data that is to be associated with the state variable, a state variable updater to change a value of at least the state variable based on the call, a data update determiner to determine whether to update corresponding data based on a change in the value of the state variable, and a data updater to update the corresponding data in accordance with the determination.

Example 18 may include the device of Example 17, wherein the data is to be in NVP form.

Example 19 may include the device of any one of Examples 17 to 18, wherein the data update determiner is to determine an extent to which data is to be made available for sharing.

Example 20 may include the device of any one of Examples 17 to 19, wherein the state variable determiner is to determine if the value of the state variable is Modified, Exclusive, Shared, or Invalid.

Example 21 may include the device of any one of Examples 17 to 20, wherein the device is a server.

Example 22 may include the device of any one of Examples 17 to 21, wherein the device is a client.

Example 23 may include the device of any one of Examples 17 to 22, wherein the state variable is to be stored on one or more of a cache on the device, or a persistent memory on the device.

Example 24 may include the device of any one of Examples 17 to 23, wherein data is to be updated from a persistent memory to a cache.

Example 25 may include the device of any one of Examples 17 to 24, wherein the device is a client mobile device.

Example 26 may include a device for storing data in coherence with other devices, comprising, means for determining a value of a state variable, wherein data on a device is associated with the state variable, means for detecting a call pertaining to one or more of a read or a write of data on the device, means for changing a value of at least the state variable based on the call, and means for determining whether to update corresponding data on one or more other devices based on a change in the value of the state variable and an evaluation of a need to propagate a change in the corresponding data to said one or more other devices.

Example 27 may include the device of Example 26, wherein the data comprises at least one name-value pair (NVP) of data.

Example 28 may include the device of any one of Examples 26 to 27, wherein the state variable is stored in one or more of a cache on the device or a persistent memory on the device.

Example 29 may include the device of any one of Examples 26 to 28, wherein the call originates from at least one of the one or more other devices.

Example 30 may include the device of any one of Examples 26 to 29, wherein the state variable includes a value of one or more of Modified, Exclusive, Shared, or Invalid.

Example 31 may include the device of any one of Examples 26 to 30, wherein the device includes a client mobile device.

Example 32 may include the device of any one of Examples 26 to 31, further including means for updating corresponding data on the one or more other devices based on an evaluation of a change of the state variable or an evaluation of the call.

Example 33 may include the device of any one of Examples 26 to 32, further including means for updating the corresponding data from a persistent memory to a cache memory.

Example 34 may include the device of any one of Examples 26 to 33, further including means for generating an Application Programming Interface (API) call to provide a channel, means for communicating the change in the value of the state variable, and means for monitoring the change in the value of the state variable.

Example 35 may include the device of any one of Examples 26 to 34, further including means for updating the corresponding data in accordance with the determination.

Example 36 may include the device of any one of Examples 26 to 35, wherein the device includes means for game play.

Various embodiments and various modules may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Example sizes/models/values/ranges may have been given, although embodiments are not limited to the same. As manufacturing techniques mature over time, it is expected that devices of smaller size and smaller tactile element size could be manufactured. In addition, well known electrical or fluidic components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments may be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. Additionally, it is understood that the indefinite articles “a” or “an” carries the meaning of “one or more” or “at least one”.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. At least one computer readable storage medium comprising one or more instructions that when executed on a computing device cause the computing device to:
determine a value of a state variable that is to be associated with data on a device;
detect a call to read and/or write the data that is to be associated with the state variable;
change a value of at least the state variable based on the call;
determine whether to update corresponding data based on a change in the value of the state variable; and
update the corresponding data in accordance with the determination.

2. The at least one computer readable storage medium of claim 1, wherein the instructions, when executed, cause a computing system to determine whether the value of the state variable is Modified, Exclusive, Shared, or Invalid.

3. The at least one computer readable storage medium of claim 1, wherein the instructions, when executed, cause a computing system to update the corresponding data stored on the one or more other devices based on the change in the value of the state variable and/or the call.

4. The at least one computer readable storage medium of claim 1, wherein the instructions, when executed, cause a computing system to store data in a persistent memory.

5. The at least one computer readable storage medium of claim 1, wherein the device is a client.

6. The at least one computer readable storage medium of claim 1, wherein the instructions, when executed, cause a computing system to generate an Application Programming Interface (API) call to provide a channel on which the device monitor changes to one or more state variables.

7. A method comprising:
determining a value of a state variable, wherein data on a device is associated with the state variable;
detecting a call pertaining to one or more of a read or a write of data on the device;
changing a value of at least the state variable based on the call; and
determining whether to update corresponding data on one or more other devices based on a change in the value of the state variable and an evaluation of a need to propagate a change in the corresponding data to the one or more other devices.

8. The method of claim 7, wherein the data comprises at least one name-value pair (NVP) of data.

9. The method of claim 7, wherein the state variable is stored in one or more of a cache on the device, or a persistent memory on the device.

10. The method of claim 7, wherein the call originates from at least one of the one or more other devices.

11. The method of claim 7, wherein the state variable includes a value of one or more of Modified, Exclusive, Shared, or Invalid.

12. The method of claim 7, wherein the device includes a client mobile device.

13. The method of claim 7, wherein the corresponding data is updated on the one or more other devices based on an evaluation of the change in the value of the state variable and an evaluation of the call.

14. The method of claim 13, wherein the corresponding data is updated from a persistent memory to a cache memory.

15. The method of claim 7, further including:
generating an Application Programming Interface (API) call to provide a channel;
communicating the change in the value of the state variable; and
monitoring the change in the value of the state variable.

16. The method of claim 7, further including updating the corresponding data in accordance with the determination.

17. A device comprising:
a state variable determiner to determine a value of a state variable that is to be associated with data on a device;
a call detector to detect a call to read and/or write data that is to be associated with the state variable;
a state variable updater to change a value of at least the state variable based on the call;
a data update determiner to determine whether to update corresponding data based on a change in the value of the state variable; and
a data updater to update the corresponding data in accordance with the determination.

18. The device of claim 17, wherein the data is to be in NVP form.

19. The device of claim 17, wherein the data update determiner is to determine an extent to which data is to be made available for sharing.

20. The device of claim 19, wherein the state variable determiner is to determine if the value of the state variable is Modified, Exclusive, Shared, or Invalid.

21. The device of claim 17, wherein the device is a server.

22. The device of claim 17, wherein the device is a client.

23. The device of claim 17, wherein the state variable is to be stored on one or more of a cache on the device, or a persistent memory on the device.

24. The device of claim 17, wherein data is to be updated from a persistent memory to a cache.

25. The device of claim 17, wherein the device is a client mobile device.
